(19) United States
(12) Patent Application Publication
(10) Pub. No.: US 2018/0341889 A1
(43) Pub. Date: Nov. 29, 2018

(54) ENTITY LEVEL CLASSIFIER USING MACHINE LEARNING

(71) Applicant: Centene Corporation, St. Louis, MO (US)

(72) Inventors: Linda Psalmonds, Bandera, TX (US); Sosunmolu Opeyemi Shoyinka, Overland Park, KS (US); Rachel Blaising, Fort Wayne, IN (US)

(21) Appl. No.: 15/989,334

(22) Filed: May 25, 2018

Related U.S. Application Data
(60) Provisional application No. 62/613,857, filed on Jan. 5, 2018.
(60) Provisional application No. 62/511,193, filed on May 25, 2017.

(51) Int. Cl. G06Q 10/06; G06K 9/00; G06K 9/62; G06N 3/04

(52) U.S. Cl. CPC G06Q 10/0635; G06N 3/04; G06K 9/6267; G06K 9/00335

(57) ABSTRACT

Methods, systems, and apparatus, including computer programs encoded on computer storage media for classify entities to identify risky behavior. One method includes obtaining one or more features associated with an entity. Identifying a likely segment from among multiple candidate segments, that is currently associated with the entity, based at least on one or more of the features. Identifying one or more other segments that were previously associated with the entity. Determining a risk profile for the entity based at least on (i) the likely segment that is currently associated with the entity, and (ii) one or more of the other segments that were previously associated with the entity. Outputting a representation of the risk profile.

### CROSS-REFERENCE TO RELATED APPLICATIONS

This applications claims the benefit of U.S. Provisional Patent Application No. 62/613,857 filed Jan. 5, 2018, and U.S. Provisional Patent Application No. 62/511,193 filed May 25, 2017, which are incorporated herein by reference.

### TECHNICAL FIELD

This specification relates generally to classifying entities, and more specifically, to classifying entities to identify current behavioral health needs as well as likely future harmful behavior, such as risky behavior.

### BACKGROUND

People can exhibit behavioral health issues that affect a person's state of being and how their behavior affects their overall health and wellness. Typical, behavior health issues include substance abuse disorders, eating disorders, and behavioral addictions.

### SUMMARY

According to some implementations, identifying current behavioral health needs may be accomplished by weighting risks associated with entities and stratifying them according to the risk of disease progression, future escalation of substance use/abuse/mental health or lifestyle harmful behaviors, and subsequent/projected healthcare costs. As described below, this specification provides a holistic clinical behavioral health treatment or intervention.

In some implementations, an entity level classifier includes a classification system trained to monitor a behavior of an entity. In particular, the classification system includes a first level classifier, a second level classifier, and a plurality of segments for monitoring the behavior of an entity. The plurality of segments define a range of behaviors associated with the entity, where each segment in the plurality of segments defines one of a meaningful behavior in the range of behaviors. Each meaningful behavior in the plurality of segments may be associated with a risky behavior rank. For example, the higher the ranked segment, the riskier the meaningful behavior. Conversely, the lower the ranked segment, the less risky the meaningful behavior.

The first level classifier is configured to receive features extracted from an entity, such as one or more characteristics of the entity, and generate an output indicative of a behavior associated with the entity in response. The output of the first level classifier can be placed in one of the segments of the plurality of segments that indicates a meaningful behavior associated with a current behavior of the entity. The second level classifier is configured to monitor the current behavior of the entity and the received extracted features to output a prediction of a future behavior of the entity. In other words, the second level classifier predicts a movement of an entity's behavior. For example, an entity exhibits a first behavior that corresponds to a current segment. The second level classifier determines a future behavior of an entity in response to analyzing the current behavior of the entity and analyzing the received extracted features of the entity. The future behavior of the entity may indicate a movement to another segment or if the future behavior does not change from the first behavior, the entity remains in the current segment.

In some implementations, a starting behavior associated with the entity, such as the starting segment, is preferable before the classification system can determine the prediction of the future behavior of the entity. Otherwise, the second level classifier will be less likely to accurately predict a movement of the behavior for the entity. In addition, without the use of the segments, the classification system would be less likely to accurately monitor the behaviors of the entity.

By predicting a behavior of the entity using the classification system, a user may take appropriate action in response to receiving the predicted behavior. For example, the classification system may determine that the movement of the behavior of the entity may be to a higher ranked segment associated with a riskier behavior. Alternatively, the classification system may determine that the movement of the behavior of the entity may be to a lower ranked segment associated with a less risky behavior. The classification system may provide this information to the user such that the user can try to curb characteristics of the entity to reduce or maintain the possibility of the prediction of the movement, depending on the direction of the movement.

In general, one innovative aspect of the subject matter disclosed described in this specification can be embodied in methods that include the actions of obtaining one or more features associated with an entity; identifying a likely segment from among multiple candidate segments, that is currently associated with the entity, based at least on one or more of the features; identifying one or more other segments that were previously associated with the entity; determining a risk profile for the entity based at least on (i) the likely segment that is currently associated with the entity, and (ii) one or more of the other segments that were previously associated with the entity; and, outputting a representation of the risk profile.

Other innovative aspects of the subject matter disclosed described in this specification can be embodied in methods that include: (1) the actions of obtaining one or more features associated with an entity; identifying the appropriate clinical behavioral health segment from among multiple candidate segments, that is currently associated with the entity, based at least on one or more of the features and behaviors, and; (2) by identifying one or more other segments that were previously associated with the entity; determining a future behavioral health risk scores and profile for the entity based at least on (i) the likely segment that is currently associated with the entity, and (ii) one or more of the other segments that were previously associated with the entity; and, outputting a representation of the risk scores and profile.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a system for entity classification.

FIG. 2 is a flow diagram of an example process for identifying behaviors using entity classification.

FIG. 3 shows an example of a computing device and a mobile computing device.

Like reference numbers and designations in the various drawings indicate like elements.

### DETAILED DESCRIPTION

Feature extraction and entity classification are important aspects when analyzing behaviors of an entity over time. Such entities may include a person, a vehicle, an internet domain or resource, a business, or a device, to name a few examples. A classification system may extract features of the entity, and may classify the entity based on the extracted features in order to identify a likely behavior of the entity, e.g. a current treatable behavioral health condition as well as a future likely harmful behavior of an entity.

In one example of how the classification system can be used, a vehicle may exhibit certain features when brought in to a dealership for routine service such as a quantity of engine rotations in revolutions per minute (RPM) over a period of time, a tire pressure, an oil level, and a fuel level. The classification system may extract these features and analyze the features to output a particular behavior identification, perhaps quantified as a score. For example, the classification system may analyze the engine RPMs over a period of time, a tire pressure measured in kilopascals (kPa), an oil level as measured by a dipstick, and a gasoline level as provided by a sensor. In addition, the classification system receives these features extracted over a period, such as 6 months. In response to analyzing each of the aforementioned features over the period, the classification system may determine that the vehicle has a behavior identification score, such as “65.” The classification can then rank that behavior identification score into one segment of multiple segments. Each of the segments can identify a type of risk associated with that behavior identification score. For example, a segment may describe a risk behavior of the vehicle experiencing low fuel economy during long periods of travel. The high engine RPMs, low tire pressure (e.g., such as 20 kPa for each tire), and a steadily decreasing gasoline level over the period of travel causing low gas mileage for the vehicle and a respective behavior identification score. The classification system can then rank the low gas mileage over a period as a medium risk behavior, or place the behavior in a third segment out of six segments, for example.

The classification system can further classify the behavior identification scores in the segments to predict a future behavior of the entity. In particular, the classification system can utilize the extracted features of the entity, the behaviors associated with each of the segments, and the behavior identification scores included in each of the segments to further determine a risk profile associated with the entity. The risk profile can include the extracted features of the entity, the behaviors associated with each of the segments, the behavior scores included in each of the segments, and a predicted future behavior of the entity.

For example, the classification system may analyze the extracted features of the vehicle and a behavior identification score in the segment for a low gas mileage behavior segment to further predict that an engine of the vehicle may fail in the near future. The classification system can include the prediction that the vehicle's engine may fail in the near future in the risk profile associated with the entity. In particular, an engine failure of the vehicle may be associated with a high-risk behavior type. The classification system may place the engine failure of the vehicle in the top segment or the sixth segment to denote the highest risk behavior. Alternatively, the classification system may analyze the extracted features of the vehicle and a behavior identification score in the segment for a low gas mileage behavior segment to further predict the vehicle may remain normal and move downward one segment in ranking.

The classification system can use the extracted features to determine restored air pressure values in the tires. In response, the classification system can move an entity behavior identification score to the bottom or first segment to denote a no risk behavior. The classification system can provide a report to a user of the current behavior of the entity, a risk associated with the current behavior, and the predicted future behavior of the entity included in the risk profile.

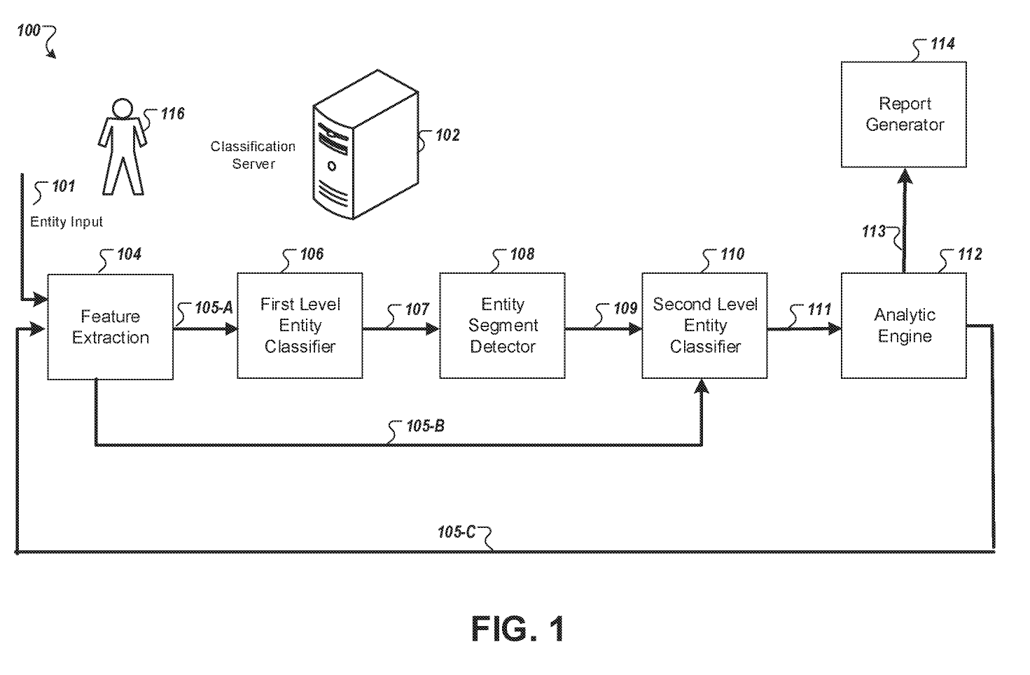

FIG. 1 illustrates an example of a system 100 for entity classification. System 100 includes a classification server 102. The classification server 102 can include one or more computers. The classification server 102 includes a feature extraction module 104, a first level entity classifier 106, an entity segment detector 108, a second level entity classifier 110, an analytic engine 112, and a report generator 114. The classification server 102 may include one or more servers connected locally or over a network.

In some implementations, the classification server 102 may receive information regarding an entity 101 from an outside source. An entity may include a person, a vehicle, an internet domain, a business, a device, or a biological environment, to name a few examples. The information regarding the entity 101 may include characteristics describing the entity 101, or can include the entity 101 itself. In the example of FIG. 1, the classification server 102 includes a feature extraction module 104 that extracts one or more features from the received information regarding the entity 101. For example, the feature extraction module 104 may extract features regarding a person, such as paid health claims, height, weight, body temperature, blood type, heritage, and other features related to that person. The classification server 102 may include an interactive method such that a user, such as user 116, can input the information regarding the entity 101. The classification server 102 may further receive a time period corresponding to how long to analyze the entity, such as five months or twenty-five months, for example. The first level entity classifier 106 may further utilize the time feature, as described in more detail below.

In another example, the entity may be a vehicle. The feature extraction module 104 may extract features regarding a vehicle such as engine rotations in RPM, tire pressure for each tire, engine oil level, and a gasoline level. The feature extraction module 104 may store an identification of an entity, such as user 116 or a vehicle, and associated features extracted from the entity in memory for further processing. In some implementations, the feature extraction module 104 may provide the extracted features 105-A of the entity to a first level entity classifier 106.

In some implementations, the classification server 102 may include a first level entity classifier 106 that receives the extracted features 105-A from the feature extraction module 104 and produces an identification of a risk behavior corresponding to the entity. Further, the first level entity classifier 106 can output a behavior identification 107 in response to receiving the extracted features 105-A and processing the extracted features 105-A. In some implementations, the first level entity classifier 106 can include a machine learning based system. The machine learning based system can include supervised, unsupervised, and semi-supervised learning systems. For example, in supervised machine learning systems, the first level entity classifier 106 may implement business rules, or may include one or more neural network layers or advanced analytical network layers. The first level entity classifier 106 may include recurrent neural network elements or modular neural network elements, or a combination of each. The neural network in the first level entity classifier 106 may be a deep neural network architecture built by stacking multiple neural network layers. The first level entity classifier 106 trains the neural network to provide output of a behavior identification 107 indicating a risk behavior corresponding to the entity. For example, the behavior identification 107 may be an identification score associated with a measure of a risk for a behavior. In this example, the behavior identification 107 may be an identification score such as “51”. The score provided by the first level entity classifier 106 may include numbers ranging from 1 through 100 or 1 through 1000, for example, where the score further indicates a measure of a risk for a behavior corresponding to the entity. The higher the behavior identification score, the higher the risky behavior of the entity.

In some implementations, the first level entity classifier 106 may include one or more neural network systems (in the supervised machine learning system) each associated with an entity type. In particular, the first level entity classifier 104 may receive an entity identification, such as a vehicle name or a person's name, along with receiving the extracted features 105-A. Upon receiving the entity identification, the first level classifier 104 may determine which neural network to use for the received entity. For example, one neural network may be associated with the vehicle entity, another neural network may be associated with the person entity, and another neural network may be associated with the internet domain entity, and so on. The first level entity classifier 106 may determine which neural network to use associated with the entity identification by performing a comparison between the entity identification and a name associated with each of the neural networks. For example, the first level entity classifier 106 may receive a vehicular name such as “car” and compare the vehicular name “car” with a name associated with each of the neural networks, such as “person,” “car,” or “website”, until a match is found. If the first level entity classifier 106 finds no match, the first level entity classifier 106 generates a new neural network, provides a name associated with the entity identification to the new neural network, and trains the new neural network using data corresponding to the entity identification. In some implementations, the classification server 102 retrieves data from the internet to train the newly created neural network.

In some implementations, the first level classifier 106 trains each of the neural networks to output a risk behavior identification score. Each of the neural networks can be trained using extracted features of similar entities related to the neural network. For example, the neural network associated with an entity, such as a vehicle, can be trained using extracted features from multiple vehicles. In this example, each of the vehicle entities may include features indicating cars having normal characteristics and broken characteristics to assist in training the vehicle neural network. The training session can be an iterative learning process for each of the neural networks in the first level classifier 106.

In some implementations, the classification server 102 may include an entity segment detector 108 that receives the behavior identification 107 from the first level entity classifier 106. Further, the entity segment detector 108 can output one or more segments and each of the behavior identifications 107 included in the one or more segments. In some implementations, the entity segment detector 108 ranks the segments in order of increasing or decreasing risk of behavior. For example, the entity segment detector 108 may include six segments in order of increasing risk of behavior. The first segment in the entity segment detector 108 may include the lowest risk for a behavior, whereas the sixth segment includes the highest risk for a behavior. Each of the segments provide for a different meaningful behavior. By utilizing meaningful behaviors for each of the segments, the first level entity classifier 106 can determine a meaningful behavior associated with the entity. In other implementations, the entity segment detector 108 may include a set of ranked segments for each entity type, as described above with relation to the first level entity classifier 106. For example, the entity segment detector 108 may include six ranked segments for the vehicle entity, six ranked segments for the person entity, and six ranked segments for the internet domain entity, to name a few examples. In some implementations, the entity segment detector 108 may include more than or less than six ranked segments. In other implementations, the entity segment detector 108 may include one set of ranked segments. The entity segment detector 108 may use one set of ranked segments for each of the entity types.

In some implementations, the entity segment detector 108 may identify one or more ranked segments associated with the entity. In particular, the entity segment detector 108 can insert the behavior identification 107 and the entity identification associated with the behavior identification 107 in one or more of the ranked segments. In one example, the first ranked segment may be used for identification scores that inclusively score between 1 and 17; the second ranked segment may be used for identification scores that inclusively score between 18 and 34; the third ranked segment may be used for identification scores that inclusively score between 35 and 51; the fourth ranked segment may be used for identification scores that inclusively score between 52 and 68; the fifth ranked segment may be used for identification scores that inclusively score between 69 and 85; and the sixth ranked segment may be used for identification scores that inclusively score between 86 and 100. Other implementations are possible for the number of ranked segments as well as a range for an inclusive score associated with each ranked segments, the six ranked segments, and the range for the inclusive score are examples. In other implementations, each of the ranked segments may be identified by a behavior type of the entity. For example, the behavior type of the identity may be associated with a rank of risky website behavior, rank of aggressiveness in personality; a rank of vehicular potential failure; or a rank of a health of an individual. In another example, the first level entity classifier 106 may receive claims for a patient seeking small doses of nicotine. The output of the first level entity classifier 106 may suggest that the individual is a smoker, and the entity segment detector 108 can insert this behavior in the lowest ranked segment, segment six. In response to the entity segment detector 108 placing the received behavior identification 107 in one of the ranked segments, the classification server 102 provides each of the ranked segments associated with the entity type as segmented data 109 to the second level entity classifier 110.

In some implementations, the classification server 102 may include a second level entity classifier 110 that receives the segmented data 109 from the entity segment detector 108 and the extracted features 105-B from the feature extraction module 104. Further, the second level entity classifier 110 can output an indication of a future behavior of the entity in response to receiving the extracted features 105-B, the segmented data 109, and collectively processing the extracted features 105-B and the segmented data 109. In some implementations, the second level entity classifier 110 may be similar to the architecture of the first level entity classifier 106, including a similar number of neural network layers and a type of the neural network layers. In other implementations, the second level entity classifier 110 may include a different neural network architecture than the first level entity classifier 106. The different neural network architecture may include a different number of neural network layers and a different type of the neural network layers.

In some implementations, the second level entity classifier 110 can perform a different function than the function performed by the first level entity classifier 106. For example, the second level entity classifier 110 analyzes the segmented data 109. The segmented data 109 includes the one or more ranked segments and each of the behavior identifications 107 included in the one or more ranked segments and a set of extracted features 105-B. The second level entity classifier 110 analyzes and processes the segmented data 109 to produce a risk profile associated with the entity. The risk profile includes extracted features of the entity, the behaviors associated with each of the segments, the behavior scores included in each of the segments, and a predicted future behavior of the entity. The second level entity classifier 110 produces an indication 111 of a future behavior of the entity to provide as output. The second level entity classifier 110 provides this indication 111 to the risk profile for storage.

In particular, the indication 111 of the future behavior of the entity provided by the risk profile can include an indication of a movement of an entity's behavior across the one or more ranked segments. In addition, the indication 111 of the future behavior of the entity includes the set of extracted features 105-B. For example, the second level entity classifier 110 may output an indication that a current behavior of the vehicle entity, which is currently located in a medium risk ranked segment, or segment three out of six for example, may move to a higher risk segment in the future in response to processing the segmented data 109 and the extracted features 105-B associated with the vehicle entity. The second level entity classifier 110 may determine that the current behavior of the vehicle entity may move one or more than one segment higher in the ranked segment set. Alternatively, the second level entity classifier 110 may determine that the current behavior of the vehicle entity may move one or more than one segment lower in the ranked segment set. The second level entity classifier 110 may update the risk profile associated with the vehicle entity to associate the predicted future behavior of the vehicle entity with the higher ranked segment or lower ranked segment. A movement to a higher segment can indicate that the vehicle entity will exhibit a behavior that includes a higher risk than a current behavior. In other implementations, the second level entity classifier 110 may determine that the current behavior of the vehicle entity does not change to a new behavior. This is because the second level entity classifier 110 indicates that the future behavior of the entity remains in the same segment as the current behavior. In particular, the second level entity classifier 110 determines the entity's behavior does not change. If no behavior change occurs, this can indicate that the entity is not exhibiting any riskier behavior traits. Alternatively, if no behavior change occurs, this can indicate that the entity is not taking further actions to improve the behavior (i.e., move to a lower ranked segment).

As mentioned above, the current behavior identification is inserted into a segment that describes a behavior of the vehicle having low gas mileage over a period. After an analysis by the second level entity classifier 110, the second level entity classifier 110 can produce an indication 111 associated with the entity that the current behavior may move to a higher risk behavior, such as the top ranked segment. In some implementations, the classification server 102 can store one or more risk profiles associated with an entity to monitor an entity's behavior over time. Specifically, the classification server 102 can monitor how the entity's behavior moves across the segments over a period of time, such as over 6 months to 20 months. This would provide useful information to a user to determine whether the entity is functioning as desired and allow the user to determine why the entity may or may not be acting in the proper manner.

In some implementations, the classification server 102 may include an analytic engine 112 that receives the indication 111 of a future behavior of an entity from the second level entity classifier 110. Further, the analytic engine 112 provides an indication 113 of the movement of the entities behavior to the report generator 114. Additionally, the analytic engine 112 provides the received extracted features 105-C included in the indication 111 to the feature extraction module 104. This starts the feature extraction and behavior classification process over for a subsequent classification.

In some implementations, the classification server 102 may include a report generator 114 that receives the indication 113 of the movement or non-movement of the entities behavior from the analytic engine 112. Further the, report generator 114 may provide a report detailing information regarding the entity. In particular, the report generator 114 may compile a report regarding the extracted features 105 of the entity, the behavior identification 107, the segmented data 109, and the indication 111 of a movement to a higher risk behavior. In some implementations, the report may include the risk profile associated with the entity, as provided by the second level classifier 110 to the analytic engine 112. The report generator 114 may provide the report to user 116 for further review. For example, the report generator 114 may provide the report to user 116 via an e-mail, a text message, or a PDF annotation, to name a few.

In the classification server 102, a feature extraction module 104 extract features from entities and provides the extracted features 105-A to a classifier. In some implementations, the extracted features 105-A further define characteristics of the features from the entities. The classifier may analyze the features to determine a behavior associated with the entity, as described above with respect to FIG. 1.

In some implementations, a classification server 102 may output an entity behavior in response to analyzing the extracted features 105-A of the entity. In particular, an entity may exhibit risky behavior when the classifier identifies common paths or common patterns of risky behavior across the extracted features. In order to determine whether the entity exhibits risky behavior, the classifier may analyze the features of the entity to determine if migration of risky behavior has occurred. Specifically, the migration of risky behavior defines an indication of whether risky behavior has occurred, and whether a risk associated with the behavior has increased or decreased in riskiness.

For example, as mentioned above, the classifier may determine whether a behavior, as identified by the classifier and associated with the entity, moves between the ranked segments in the entity segment detector 106. Each segment in the entity segment detector 106 defines a behavioral classification of an entity. The behavioral classification of the entity may include a behavior of the entity and a risk of the behavior of the entity over a particular period, such as 6 months, for example. The classification server 102 may monitor the behavior of the entity for a longer period or shorter period. In some implementations, a classification system may continue to monitor a behavior of an entity as long as the classification system continues to receive extracted features associated with the entity. The classification server 102 may loop the output of the classification server 102 to the input of the feature extraction module 104 to improve the classification robustness of the classification server 102.

In other implementations, such as health system implementations, individuals, such as a patient, may visit a pharmacy and a doctor at a hospital multiple times a month. The patient may receive various prescriptions for medicine from the pharmacy and the doctor. In response, the hospital and the pharmacy may bill an insurance claim to a designated payer, such as a health insurance company associated with the patient. The health insurance company may pay a portion of or the entire insurance claim. In typical situations, a patient may seldom visit a hospital and/or pharmacy for medicine. However, some patients may abuse the medical system by obtaining more medical prescriptions than necessary and try to conceal an addiction to the medical prescriptions.

The classification server 102, used by the health insurance company, can analyze the paid claims and other information to determine whether the patient has a substance use disorder (SUD) and whether a behavior of the patient is moving towards or away from SUD. In particular, the classification server may receive the entity input 101, as patient information, and provide the entity input 101 into the feature extraction module 104. The feature extract module 104 may extract one or more features 105-A to provide to the first level entity classifier 106. For example, the features 105-A may include patient information that includes paid claims and the other information such as behavioral health of the patient, a provider of the patient, pharmacy drugs, dosages, and other pharmacy utilization, used by the patient; data including policies/infrastructure/practices/laws near patient's residence, crime data near patient's residence; and, patient member information such as demographics, clinical notes, and case management data. The feature extraction module 104 may provide the features 105-A to the first level entity classifier 106.

In some implementations, the segmentation model features an algorithm that infuses best-in-class clinical and analytical expertise with evidence-based information and claims data. The algorithm blends financial and clinical risk, and considers behavior patterns and prior treatment to place individuals into one of six unique SUD segments. If an entity is in Segment 4: Harmful Use, the entity will receive appropriate treatment for the substance use behavior. If the same entity, also has a highly predicted future high cost and no treatment (segment 1) substance behavior, clinicians may include appropriate prevention strategies to the current treatment. Among the innovative features of this model is its ability to empower health plans to identify members that migrate from one segment to another. Furthermore, SUD segmentation allows for the prediction of such segment migration and analysis of the associated costs. This allows the model to specialize in early identification and prevention, before a high-risk individual's substance abuse worsens.

For example, sometimes addiction worsens; a member with SUD may progress and move to a different segment (e.g., a member in Segment 5 (using nicotine) may begin using more severe drugs (like opioids) and migrate to Segment 1 or 2). The predictive algorithm embedded in the segmentation model identifies individuals who are at the highest risk of migration. The predictive analytics can be used by health plans to target members/populations and intervene proactively. The classification system can use the extracted features to determine the overall behavioral health needs of a member of patient as they are today and their overall behavioral health in the future. This includes SUD, mental health, and comorbid disease management conditions, behaviors and lifestyles.

The entity may include a member with more than one behavioral health condition. Because entity information is fed through classifier module, segment entity detector, and secondary level entity classifier, the immediately available overall behavioral health needs of the member/patient are revealed for holistic behavioral health treatment and prevention for future harmful behaviors.

As mentioned above, the first level entity classifier 106 produces a behavior identification 105 score in response to analyzing the extracted features 105-A received from the feature extraction module 104. The first level entity classifier 106 provides the behavior identification 107 score to the entity segment detector 108. The behavior identification 107 score may indicate a behavioral health associated with the patient. The entity segment detector 108 places the behavior identification 107 score in one of the ranked segments. For example, from the bottom of the ranked segments, the first segment can be a “No SUD” segment, the second segment can be a “Nicotine Only SUD Diagnosis (DX)” segment, the third segment can be a “Harmful Use Members (Recipe (RX) Abuse and No SUD DX)” segment, the fourth segment can be a “Non-High Cost SUD Members (All DX and RX)” segment, the fifth segment can be a “High Cost SUD Member Some Treatment (All DX and Rx)” segment, and the sixth segment can be a “High Cost SUD Member No Treatment (All DX and Rx)” segment. In response to the entity segment detector 108 placing the received behavior identification 107 for the patient in a ranked segment, such as the “High Cost SUD Member Some Treatment (All DX and Rx)” segment, the classification server 102 provides each of the ranked segments associated with that entity type, a patient, as segmented data 109 to the second level entity classifier 108.

In another example, the entity segment detector 108 may include more than six segments, such as 10 segments. Starting from the bottom, the first segment may be “No Mental Health (MH) DX or RX,” the second segment may be “Other Mental health,” the third segment may be “Personality Disorders,” the fourth segment may be “Intellectual Disabilities/Autism disorders,” the fifth segment may be “Mood Disorder, Depression,” the sixth segment may be “Anxiety Disorders/Phobias,” the seventh segment may be “Eating Disorders,” the eighth segment may be “Mood Disorder, Bipolar,” the ninth segment may be “Schizoaffective disorder,” and the tenth segment may be “Psychotic/Schizophrenic Disorders.” The segments may increase in mental health need from the bottom segment to the top segment.

The second level entity classifier 110 receives the segmented data 109 and new extracted feature data 105-B from the feature extraction module 104. The second level entity classifier 110 can output an indication 111 of a future behavior of the patient in response to receiving the extracted features 105-B, the segmented data 109, and collectively processing the extracted features 105-B and the segmented data 109. For example, the indication 111 of the future behavior may indicate that the behavior of the patient may move from the “High Cost SUD Member Some Treatment (All DX and Rx)” segment to the “Nicotine Only SUD DX” segment. The second level entity classifier 110 provides an indication 111 to the analytic engine 112 denoting of the predicted change to the new segment. In response, the analytic engine 110 provides the received extracted features 105-C included in the indication 111 to the feature extraction module 104. By providing the indication 111 to the feature extraction module 104 as a continuous feed into system 100, the system 100 can continuously improve learning the behavior of each patient.

In some implementations, such as computer implementations, malware individuals may publish and/or post a webpage containing content dedicated to garnering attention from other individuals' viewing and interacting with the webpages. In particular, the malware individuals can post the webpage that contains content that attract the other individuals to view and interact with that webpage. For example, other individuals interacting with the content in the webpage may include liking a particular feature included in the content, commenting on a particular feature included in the content, or double clicking an interactive button on a particular feature included in the content. In response to the webpage gaining enough popularity from users interacting with the webpage, the malware individuals who published the webpages with the content may remove the content and replace the content with malware. In particular, once the webpages determine that individuals interact with content that was published by the malware individuals, the webpages may continue to display the areas that displayed the original content. In these computer systems, such as an internet system, webpages will typically show content related to what users desire to see or interact with most often. However, where the original content once existed on the webpage, now exists the malware in the original contents place. Now, individuals who access that webpage and interact with the malware will be redirected to another malware webpage. The other malware webpages can inject malware into a client device used by a user to access the malware webpage.

This malware webpage example is another entity that the classification system can classify to identify a risk associated with the webpage's behavior. For example, the classification system may receive an entity, such as the webpage that includes content dedicated to collecting attention from other individuals viewing and interacting with the webpage. The feature extraction module 104 receives the webpage and extracts features from the webpage. The feature extraction module 104 may extract features from the webpage such as a URL associated with the webpage, each of the interactive components of the webpage, content included on the webpage, data included in the content of the webpage, a number of interactions associated with each portion of the interactive components, and the content included in the webpage.

In some implementations, the feature extraction module 104 provides the extracted features 105-A to the first level entity classifier 106. The first level entity classifier 106 receives the extracted features 105-A of the webpage that can include a URL associated with the webpage, each of the interactive components of the webpage, content included on the webpage, data included in the content of the webpage, and a number of interactions associated with each portion of the interactive components. As a result, the first level entity classifier 106 processes the received features through the included neural network. In response to the first level entity classifier 106 processing the received extracted features 105 of the webpage, the first level entity classifier 106 produces a behavior identification 107. For example, the first level entity classifier 106 produces a behavior identification 107 score of 15 to denote a minimal behavioral risk. In another example, the first level entity classifier 106 may receive content included on the webpage that contains keywords associated with the malware. The first level classifier 106 can be trained to output a ranking indicator of how nefarious the received keywords are included on the webpage. The higher the ranking indicator, the more nefarious the keywords may be, and as a result, the higher probability that the content included on the webpage contains malware. As noted with typical websites, the web site includes content that web-viewers can interact with, like, or provide comments to share an opinion on the content.

The first level entity classifier 106 provides the behavior identification 107 score of “15” to the entity segment detector 108. As mentioned above, the entity segment detector 108 may rank a number of segments in order of increasing or decreasing risk of behavior. For example, the entity segment detector 106 may include segments in order of increasing risk of behavior. The entity segment detector 108 may insert the received behavior identification 107 and an associated entity identification in the first ranked segment of the set of segments. The first ranked segment is included for scores between 1 and 17. The first ranked segment further defines the lowest risk behavior of the entity. In response to the entity segment detector 108 inserting the received behavior identification 107 score of 15 in the first ranked segment, the classification server 102 provides each of the ranked segments associated with that entity type as segmented data 109 to the second level entity classifier 110.

The second level entity classifier 110 receives the segmented data 109 and new extracted feature data 105-B from the feature extraction module 104. The second level entity classifier 110 can output an indication of a future behavior of the entity in response to receiving the extracted features 105-B, the segmented data 109, and collectively processing the extracted features 105-B and the segmented data 109. For example, the second level entity classifier 110 analyzes the one or more ranked segments included in the segmented data 109, as well as the behavior identifications 107 included in each of the one or more ranked segments to include in a risk profile associated with the entity. As one of the ranked segments includes the behavior identification 107 score of 15, the second level entity classifier 110 analyzes the newly received extracted features 105-B and determines that no future movement will occur across the ranked segment set. The newly received extracted features 105-B did not exhibit any further features directed to a change in behavior. The second level entity classifier 110 provides an indication 111 to the analytic engine 112 denoting that no behavior change occurs. In some implementations, the second level entity classifier 110 may provide the risk profile associated with the entity in the indication 111 to the analytic engine 112.

The analytic engine 112 receives the indication 111 that the current behavior may not move across segments. In response, the analytic engine 110 provides the received extracted features 105-C included in the indication 111 to the feature extraction module 104. In some implementations, the feature extraction module 104 compares the received extracted features 105-C to extracted features from an entity input 101. The feature extraction module 104 compares the differences between the received extracted features 105-C to extracted features from the entity input 101 to a threshold. Should the feature extraction module 104 determine that the differences are less than the threshold, the feature extraction module 104 can provide the received extracted features 105-C to the first level entity classifier 106. Otherwise, the feature extraction module 104 provides the extracted features from the entity input 101 to the first level entity classifier 106. In other implementations, the feature extraction module 104 may provide both extracted features from the entity input 101 and the received extracted features 105-C to the first level entity classifier 106. In other implementations, the feature extraction module 104 may average the extracted features from the entity input 101 and the received extracted features 105-C and in response, provide an averaged feature extraction 105-A to the first level entity classifier 106 for subsequent classification.

In a subsequent iteration of the classification, the classification server 102 may receive newly received extracted features 105-A and pass the newly received extracted features 105-A to the first level entity classifier 106. The newly received extracted features 105-A may contain features that indicate that the malware attackers removed content associated with the webpage. In addition, the webpage now includes new content that further includes redirecting information to another webpage not associated with a current webpage. The first level entity classifier 106 may recognize this as risky behavior and produce a behavior identification 107 that includes a score of 65. The entity segment detector 108 receives the behavior identification 107 that includes the score of 65 and inserts the behavior identification 107 into the fourth ranked segment. In response to the entity segment detector 106 inserting the received behavior identification 107 in to the fourth ranked segment, the classification server 102 provides each of the ranked segment associated with the entity type as segmented data 109 to the second level entity classifier 110. The second level entity classifier 110 analyzes the segmented data 109 to determine an indication 111 of a future behavior of the webpage entity.

In this particular example, the second level entity classifier 110 determines the entity has exhibited a behavior movement from the first ranked segment to the fourth ranked segment. As a result, the second level entity classifier 110 can predict an indication of a future behavior of the webpage entity that may continue to move upward to a higher ranked segment. This indication 113 may indicate to the user, such as user 116, that a predicted risky behavior, such as the removal of content from a webpage and the insertion of redirecting formation in place of the content, is recognized by the classification server 102. The second level entity classifier 110 provides this indication 111 to the analytic engine 112. The analytic engine 112 provides the received extracted features 105-C to the feature extraction module 104. Additionally, the analytic engine 112 provides the indication 113 of the prediction of the behavior of the entity to the report generator 114. This classification process continues over a period, such as 6 months to 1 year, to monitor the behavior of the entity.

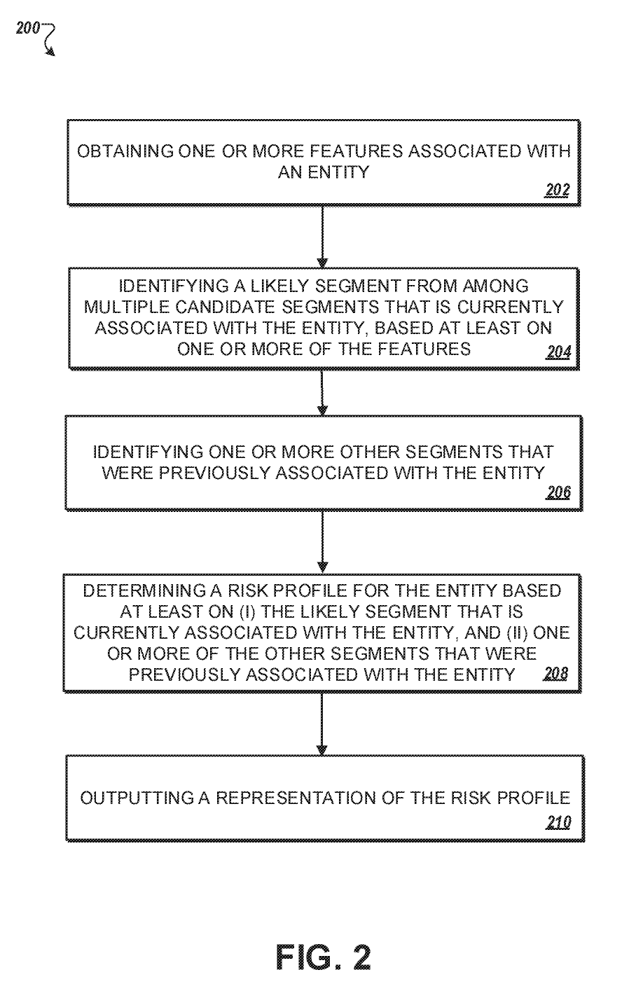

FIG. 2 illustrates a flowchart of process 200 for classifying entities. For convenience, the process 200 will be described as being performed by a system of one or more computers located in one or more locations. For example, classification entity systems, such as the computing system described above, can perform the process 200.

During 202, the classification server 102 obtains one or more features associated with an entity. In particular, the classification server 102 includes a feature extraction module 104 that extracts one or more features from the received information regarding the entity 101. The one or more features can describe the characteristics associated with the entity, such as engine rotations in RPM, tire pressure for a tire, engine oil level, and a gasoline level for a vehicle.

During 204, the classification server 102 identifies a likely segment from among multiple candidate segments that is currently associated with the entity, based at least on one or more of the features. In particular, the classification server 102 includes an entity segment detector 108 that inserts a behavior identification 107 and an entity identification associated with the behavior identification 107 in an identified ranked segment. For example, the behavior identification 107 may be placed in a second segment from the ranked segments.

During 206, the classification server 102 identifies one or more segments that were previously associated with the entity. In particular, the classification server 102 includes a second level entity classifier 110 to analyze segmented data 109 associated with a previous behavior of an entity. For example, the segmented data 109 includes the one or more ranked segments and each of the behavior identifications 107 included in the one or more ranked segments and a set of extracted features 105-B from the entity 101.

During 208, the classification server 102 determines a risk profile for the entity based at least on (i) the likely segment that is currently associated with the entity, and (ii) one or more of the other segments that were previously associated with the entity. In particular, the classification server 102 includes the second level entity classifier 110 to produce a risk profile associated with the entity. The risk profile includes extracted features of the entity, the behaviors associated with each of the segments, the behavior scores included in each of the segments, and a predicted future behavior of the entity.

During 210, the classification server 102 outputs a representation of the risk profile. In particular, the risk profile produces an indication 111 of a future behavior of the entity to provide as output. The indication 111 of the future behavior of the entity dictates an indication of a movement of an entity's behavior across the one or more ranked segments. In other implementations, the risk profile is included in the indication 111 produced by second level entity classifier 110 and provided as output to the analytic engine 112.

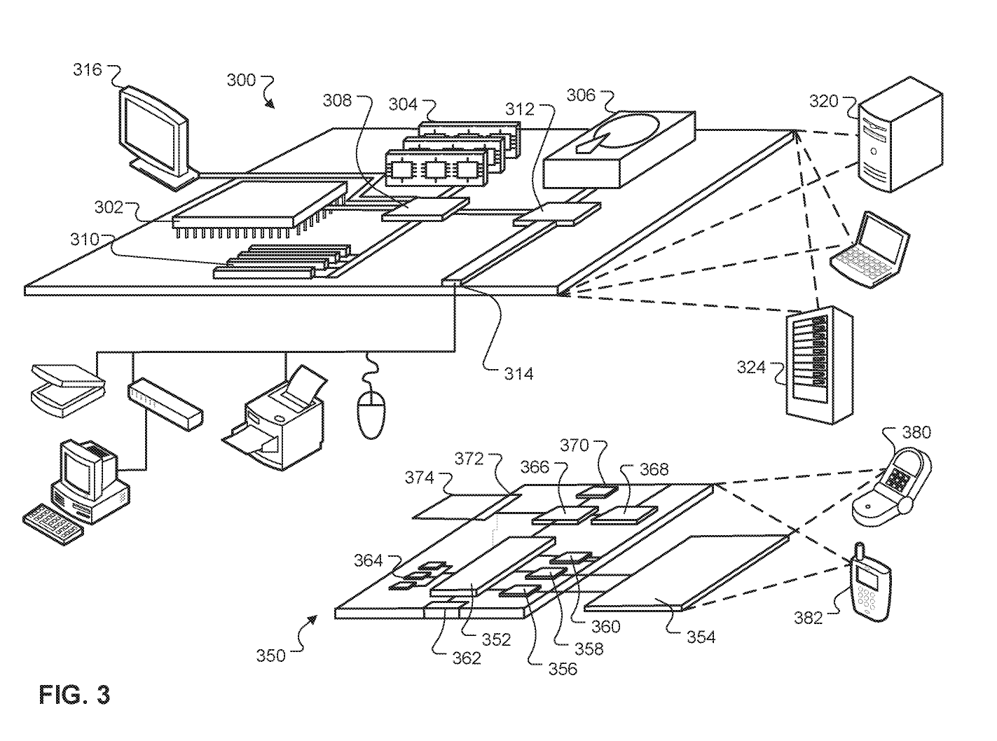

FIG. 3 shows an example of a computing device 300 and a mobile computing device 350 that can be used to implement the techniques described here. The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine-readable mediums (for example, the memory 304, the storage device 306, or memory on the processor 302).

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device (not shown), such as a mobile computing device 350. Each of such devices may contain one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provided as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier, such that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry where necessary. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 368 using a radio-frequency. In addition, short-range communication may occur, such as using a Bluetooth, WiFi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, etc.) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining one or more features associated with an entity;
identifying a likely segment from among multiple candidate segments, that is currently associated with the entity, based at least on one or more of the features;
identifying one or more other segments that were previously associated with the entity;
determining a risk profile for the entity based at least on (i) the likely segment that is currently associated with the entity, and (ii) one or more of the other segments that were previously associated with the entity; and
outputting a representation of the risk profile.

2. The computer-implemented method of claim 1, wherein obtaining one or more features associated with an entity further comprising:
extracting the one or more features associated with the entity;
obtaining an identification of the entity; and
storing the identification of the entity and the one or more extracted features associated with the entity.

3. The computer-implemented method of claim 1, wherein identifying the likely segment from among the multiple candidate segments further comprising:
identifying the likely segment from among the multiple candidate segments in response to determining a behavior identification score associated with entity and the extracted features.

4. The computer-implemented method of claim 3, further comprising:
determining the likely segment to associate with the behavior identification score based on comparing a value of the behavior identification score to a range of scores associated with each of the multiple candidate segments.

5. The computer-implemented method of claim 1, wherein the risk profile includes the one or more features associated with the entity, a behavior associated with each of the multiple candidate segments, one or more behavior scores included in each of the multiple candidate segments, and a predicted future behavior of the entity.

6. The computer-implemented method of claim 5, wherein the predicted future behavior of the entity comprises predicting a movement from the likely segment that is currently associated with the entity to another segment based on the one or more features associated with the entity.

7. The computer-implemented method of claim 1, wherein determining the risk profile for the entity further comprising:
determining the risk profile for the entity over a predetermined period of time.

8. The computer-implemented method of claim 1, wherein outputting the representation of the risk profile further comprising:
providing the representation of the risk profile to a user over a network.

9. A system comprising:
one or more computers and one or more storage devices storing instructions that are operable, when executed by the one or more computers, to cause the one or more computers to perform operations comprising:
obtaining one or more features associated with an entity;
identifying a likely segment from among multiple candidate segments, that is currently associated with the entity, based at least on one or more of the features;
identifying one or more other segments that were previously associated with the entity;
determining a risk profile for the entity based at least on (i) the likely segment that is currently associated with the entity, and (ii) one or more of the other segments that were previously associated with the entity; and
outputting a representation of the risk profile.

10. The system of claim 9, wherein obtaining one or more features associated with an entity further comprises:
extracting the one or more features associated with the entity;
obtaining an identification of the entity; and
storing the identification of the entity and the one or more extracted features associated with the entity.

11. The system of claim 9, wherein identifying the likely segment from among the multiple candidate segments further comprising:
identifying the likely segment from among the multiple candidate segments in response to determining a behavior identification score associated with entity and the extracted features.

12. The system of claim 11, further comprising:
determining the likely segment to associate with the behavior identification score based on comparing a value of the behavior identification score to a range of scores associated with each of the multiple candidate segments.

13. The system of claim 9, wherein the risk profile includes the one or more features associated with the entity, a behavior associated with each of the multiple candidate segments, one or more behavior scores included in each of the multiple candidate segments, and a predicted future behavior of the entity.

14. The system of claim 13, wherein the predicted future behavior of the entity comprises predicting a movement from the likely segment that is currently associated with the entity to another segment based on the one or more features associated with the entity.

15. The system of claim 9, wherein determining the risk profile for the entity further comprising:
determining the risk profile for the entity over a predetermined period of time.

16. The system of claim 9, wherein outputting the representation of the risk profile further comprising:
providing the representation of the risk profile to a user over a network.

17. A non-transitory computer-readable medium storing software comprising instructions executable by one or more computers which, upon such execution, cause the one or more computers to perform operations comprising:
one or more computers and one or more storage devices storing instructions that are operable, when executed by the one or more computers, to cause the one or more computers to perform operations comprising:
obtaining one or more features associated with an entity;
identifying a likely segment from among multiple candidate segments, that is currently associated with the entity, based at least on one or more of the features;
identifying one or more other segments that were previously associated with the entity;
determining a risk profile for the entity based at least on (i) the likely segment that is currently associated with the entity, and (ii) one or more of the other segments that were previously associated with the entity; and
outputting a representation of the risk profile.

18. The computer-readable medium of claim 17, wherein obtaining one or more features associated with an entity further comprises:
extracting the one or more features associated with the entity;
obtaining an identification of the entity; and
storing the identification of the entity and the one or more extracted features associated with the entity.

19. The computer-readable medium of claim 17, wherein identifying the likely segment from among the multiple candidate segments further comprising:
identifying the likely segment from among the multiple candidate segments in response to determining a behavior identification score associated with entity and the extracted features.

20. The computer-readable medium of claim 19, further comprising:
determining the likely segment to associate with the behavior identification score based on comparing a value of the behavior identification score to a range of scores associated with each of the multiple candidate segments.
